(19) United States
(12) Patent Application Publication
(10) Pub. No.: US 2025/0051522 A1
(43) Pub. Date: Feb. 13, 2025

(54) FUNCTIONALIZED POLY(ARYL ETHER SULFONE) COPOLYMERS

(71) Applicant: Solvay Specialty Polymers USA, LLC, Alpharetta, GA (US)

(72) Inventor: Kamlesh P. NAIR, Alpharetta, GA (US)

(21) Appl. No.: 18/718,936

(22) PCT Filed: Dec. 21, 2022
(86) PCT No.: PCT/EP2022/087247

§ 371 Date: Jun. 12, 2024

Related U.S. Application Data
(60) Provisional application No. 63/293,106, filed on Dec. 23, 2021.

(30) Foreign Application Priority Data
Mar. 11, 2022 (EP) 22161495.1

(51) Int. Cl. C08G 75/23

(52) U.S. Cl. CPC C08G 75/23; C08G 2150/00; C08G 2340/00

(57) ABSTRACT

The invention relates to a side-chain functionalized poly(aryl ether sulfone) (PAES) copolymer (P1), to the process for preparing the copolymer (P1), and to its use in the preparation of a membrane, a composite material or a coating. The copolymer (P1) comprises PAES recurring units (R_{P1}) and PAES side-chain functionalized recurring units (R*_{P1}).

### CROSS-REFERENCE TO RELATED APPLICATIONS

This application claims priority to U.S. provisional patent application No. 63/293,106 filed on Dec. 23, 2021 and European patent application No. 22161495.1 filed on Mar. 11, 2022, the whole content of these applications being incorporated herein by reference for all purposes.

### TECHNICAL FIELD

The present disclosure relates to a side-chain functionalized copolymer (P1) and to the process for preparing the side-chain functionalized copolymer (P1). The present invention also relates to the use of the copolymer (P1) for preparing functional membranes, i.e. hydrophobic, hydrophilic, bio-labeled, membranes with fluorescent tags, the use of the copolymer (P1) in composite materials, 3D printing applications, and the use of the copolymer (P1) in functional coatings.

### BACKGROUND ART

Poly(aryl ether sulfones) (PAES) polymers belong to the group of high-performance thermoplastics and are characterized by high heat distortion resistance, good mechanical properties, excellent hydrolytic resistance and an inherent flame retardance. Versatile and useful, PAES polymers have many applications in electronics, electrical industry, medicine, general engineering, food processing and 3D printing. PAES polymers may be used in injected molded articles, composites and membranes such as for water purification or hemodialysis.

PAES are made by polycondensation reactions typically using a dihalodiphenyl sulfone (the sulfone monomer) along with at least one aromatic diol monomer such as Bisphenol A (“BPA”), biphenol (“BP”) or dihydroxydiphenyl sulfone (DHDPS) also known as Bisphenol S (“BPS”).

A commercially important group of PAES includes polysulfone polymers identified herein as polysulfones, in short PSU. PSU polymers contain recurring units derived from the condensation of BPA and a dihalogen sulfone monomer, for example 4,4′-dichlorodiphenyl sulfone (DCDPS). Such PSU polymers are commercially available from Solvay Specialty Polymers USA LLC under the trademark UDEL®. The Tg of PSU is typically 185° C. The structure of the repeating units of such a PSU polymer is shown below:

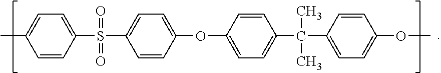

Another important group of PAES includes polyethersulfone polymers, in short PES. PES polymers derive from the condensation of BPS and a dihalogen sulfone monomer, for example DCDPS. Such PES polymers are commercially available from Solvay Specialty Polymers USA LLC under the trademark VERADEL®. The Tg of PES is typically 220° C. The structure of the repeating units of such a PES polymer is shown below:

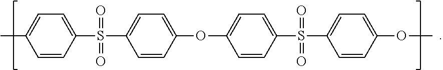

Another important group of PAES includes poly(biphenyl ether sulfone) polymers, in short PPSU. PPSU is made by reacting 4,4′-biphenol (BP) and a dihalogen sulfone monomer, for example DCDPS, and it is notably commercially available from Solvay Specialty Polymers USA LLC under the tradename Radel®. The Tg of PPSU is typically 220° C. The structure of the repeating units of such PPSU polymer is shown below:

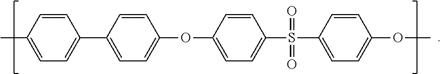

While PAES polymers have many advantages, and good physical properties, it is sometimes desirable to tune these properties to improve performance in specific applications. For example, in membrane filtration, increasing the hydrophilicity of PAES is sometimes desired to improve key membrane performance attributes such as flow rate. Basic property modification, including but not limited to hydrophilicity, is oftentimes achieved by combining two homopolymers to make block copolymers that possess the combination of intrinsic properties of each individual homopolymer. For example, in membrane applications, a PAES homopolymer can be covalently linked to a hydrophilic homopolymer to synthesize a new PAES-hydrophilic block copolymer possessing superior membrane performance owing to the enhanced flow caused by the hydrophilic component while retaining the mechanically robust and amorphous pore structure of the PAES component.

The present invention provides a side-chain functionalized copolymer and a process for preparing such copolymers. These functionalized copolymers are complex polymer architectures useful in may different applications, for instance to prepare membranes, composite materials and coatings.

### SUMMARY OF INVENTION

An aspect of the present disclosure is directed to a side-chain functionalized poly(aryl ether sulfone) (PAES) copolymer (P1) as defined in claim 1. The copolymer (P1) comprises poly(aryl ether sulfone) (PAES) recurring units (R_{P1}), as well as PAES recurring units (R*_{P1}) with pendant groups, more precisely PAES recurring units (R*_{P1}) functionalized with side-chain groups.

Recurring units (R*_{P1}) contain a thio-ether functional group which possesses several advantages. It is a stable but at the same time versatile functional group which can be easily modified to fine tune the property of the PAES copolymer (P1).

The copolymer (P1) has a glass transition temperature Tg being equal to or greater than the Tgₕ of the homopolymer consisting essentially of the same recurring units (R_{P1}), said glass transition temperatures being measured by differential scanning calorimetry (DSC), preferably according to ASTM D3418. The copolymer (P1) preferably has a Tg>Tgₕ, more preferably Tg≥5° C.+Tgₕ, yet more preferably Tg≥7° C.+Tgₕ, yet even more preferably Tg≥10° C.+Tgₕ.

The present invention also relates to a process for preparing copolymers (P1) from a copolymer (P0) comprising ally and/or functional groups comprising carbon-carbon double bonds which are reactive and can therefore be used to efficiently modify copolymers. The present invention therefore provides a way to introduce functionality in the PAES polymers and the resulting copolymers can then be used further in various applications, for example to prepare membranes.

The present invention also relates to the use of the copolymer (P1) in the preparation of a membrane, a composite material or a coating.

### DISCLOSURE OF THE INVENTION

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

In the present application:
the term “comprising” (or “comprise”) includes “consisting essentially of”(or “consist essentially of”) and also “consisting of” (or “consist of”);
the use of the singular ‘a’ or ‘one’ herein includes the plural unless specifically stated otherwise; and
it should be understood that the elements, properties and/or the characteristics of a (co)polymer, product or article, a process or a use, described in the present specification, may be combined in all possible ways with the other elements, properties and/or characteristics of the (co)polymer, product or article, process or use, explicitly or implicitly, this being done without departing from the scope of the present description.

The term “consisting essentially of” in relation to a composition, product, article, polymer, process, method, etc is intended to mean that any additional element or feature which may not be explicitly described herein and which does not materially affect the basic and novel characteristics of such a composition, product, article, polymer, process, method, etc can be included in such an embodiment.

In the present disclosure, the term “recurring unit” designates the smallest unit of a PAES polymer which is repeating in the chain and which is composed of a condensation of a diol compound and a dihalo compound. The term “recurring unit” is synonymous to the terms “repeating unit” and “structural unit”.

As used herein, the term “homopolymer” encompasses a polymer which only has one type of recurring unit.

As used herein, the term “copolymer” encompasses a polymer which has two or more different types of recurring units.

### Copolymer (P1)

The present invention relates to a side-chain functionalized copolymer (P1).

Copolymer (P1) comprises at least two types of recurring units, namely recurring units (R_{P1}) of formula (M) and recurring units (R*_{P1}) of formula (N), described below.

The recurring units (R*_{P1}) are functionalized with functional groups which can be selected from the group consisting of:
—(CH₂)ⱼ—S—R₂ wherein j is an integer from 3 to 7 and/or
—(CH₂)ₖ—CH—CH₂(CH₃)—S—R₂ wherein k is an integer from 0 to 4, and R₂ is independently selected from the group consisting of:
—(CH₂)ᵤ—COOH, with u being an integer from 1 to 5, preferably u being 1 or 2,
—(CH₂)ₖ—OH, with k being an integer from 1 to 5, preferably k being 1 or 2,
—(CH₂)ₚ—NRₐR_{b}, with p being an integer from 1 to 5, and a and b being independently a C1-C6 alkyl or H, with the proviso that Rₐ and R_{b} cannot be both CH₃; preferably —NRₐR_{b} is —NH₂ and preferably p being 1 or 2,
—(CH₂)_{q}—SO₃Na, with q being an integer from 1 to 5, preferably q being 1, 2 or 3,
—(CH₂)ₐ—COCH₃, with a being an integer from 0 to 10,
—(CH₂)ᵣ—Si(OCH₃)₃, with r being an integer from 1 to 5, preferably r being 1, 2 or 3,
—(CH₂)ₛ—(CF₂)ₜ—CF₃, with s being an integer from 1 to 5, preferably 1 or 2, and t being an integer from 1 to 10, preferably between 5 to 9,
—C(O)—R_{c}, with Rₑ being a C1-C6 alkyl or H, preferably H,
—(CH₂)v—CH₃, with v being an integer from 5 to 30, preferably v being an integer from 8 to 20, and
—(CH₂)w—Ar, with w being an integer from 1 to 10 and Ar comprises one or two aromatic or heteroaromatic rings, for example one or two benzene rings.

The functional groups of copolymer (P1) are internal functionalizations, within the copolymer backbone. The internal functionalizations result from a step-growth polymerization, in the presence of an allyl-substituted monomer, which advantageously makes the system versatile as the content of functionality can be adjusted by varying the content of allyl-substituted monomer in the reaction mixture. The allyl-substituted monomer comprises two pendant allyl group side chains which according to the present invention each comprises from 3 to 7 carbon atoms.

The copolymer (P1) of the present invention comprises:
recurring units (R*_{P1}) of formula (M):

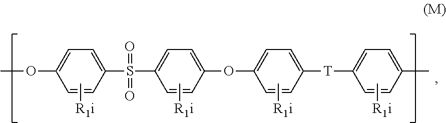

recurring units (R*_{P1}) of formula (N):

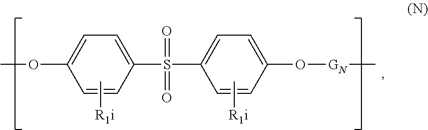

wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is an integer independently selected from 0 to 4;
T is selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ—and —(CF₂)ₘ—with m being an integer from 1 to 6; an aliphatic divalent group, linear or branched, of up to 6 carbon atoms; and combinations thereof;
G_{N} is selected from the group consisting of at least one of the following formulas (G_{N1}) to (G_{N6}):

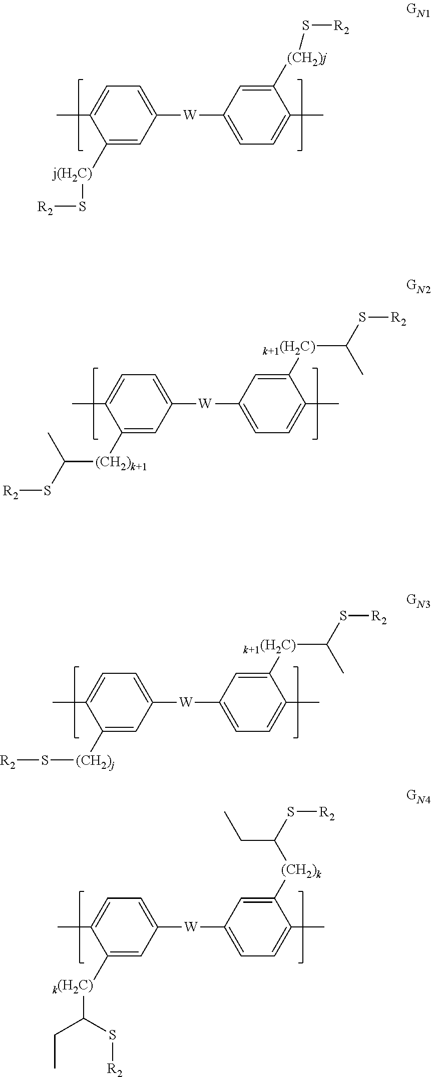

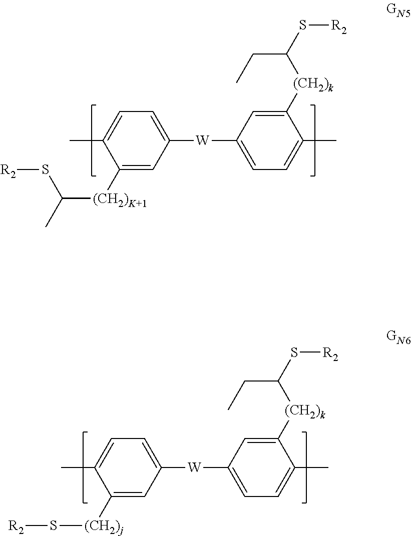

in which, in formulae (G_{N1}) to (G_{N6}),
W is a bond or —SO₂—, preferably —SO₂—;
each k is independently an integer from 0 to 4;
each j is independently an integer from 3 to 7;
each R₂ is independently selected from the group consisting of:
   —(CH₂)ᵤ—COOH, with u being an integer from 1 to 5, with the proviso that when T and W are both —SO₂— then u is not 1 or 2,
   —(CH₂)ₖ—OH, with k being an integer from 1 to 5,
   —(CH₂)ₚ—NRₐR_{b}, with p being an integer from 1 to 5, and a and b being independently a C1-C6 alkyl or H, with the provisio that Rₐ and R_{b} cannot be both CH₃,
   —(CH₂)_{q}—SO₃Na, with q being an integer from 1 to 5,
   —(CH₂)ₐ—COCH₃, with a being an integer from 0 to 10
   —(CH₂)ᵣ—Si (OCH₃)₃, with r being an integer from 1 to 5,
   —(CH₂)ₛ—(CF₂)ₜ—CF₃, with s being an integer from 1 to 5 and t being an integer from 1 to 10,
   —C(O)—R_{c}, with Rₑ being a C1-C6 alkyl or H, preferably H,
   —(CH₂)ᵥ—CH₃, with v being an integer from 5 to 30, and
   —(CH₂)_{w}—Ar, with w being an integer from 1 to 10 and Ar comprising one or two aromatic or heteroaromatic rings, for example one or two benzene rings, and wherein the copolymer (P1) has a glass transition temperature Tg being equal to or greater than the Tgₕ of the homopolymer consisting essentially of the same recurring units (R_{P1}), preferably has a Tg>Tgₕ, more preferably Tg≥5° C.+Tgₕ, yet more preferably Tg≥7° C.+Tgₕ, yet even more preferably Tg≥10° C.+Tgₕ, said glass transition temperatures being measured by differential scanning calorimetry (DSC), preferably according to ASTM D3418.

Copolymer (P1) of the present invention is in the form of a racemate product. Due to the presence of the base and high temperature during polymerization, the allyl-substituted monomer usually racemizes during polymerization in such a way that the position of the double bond may change along the side chains. This leads to the formation of molecules differing from each others by the fact that the double bond may be at the end of the side chain or one carbon before the end of the side chain. The amount of racemization depends on the reaction time and temperature.

In some embodiments, copolymer (P1) is such that in recurring units (R_{P1}), T is selected from the group consisting of a bond, —SO₂—, —C(CH₃)₂— and a mixture therefrom. Copolymer (P1) of the present invention may, for example, comprise recurring units (R_{P1}) in which T is —C(CH₃)₂— and recurring units (R_{P1}) in which T is —SO₂—.

T in recurring units (R_{P1}) is preferably —C(CH₃)₂—.

In some embodiments, the copolymer (P1) is such that each R₁ is independently selected from the group consisting of a C1-C12 moiety optionally comprising one or more than one heteroatoms; sulfonic acid and sulfonate groups; phosphonic acid and phosphonate groups; amine and quaternary ammonium groups.

In some embodiments, copolymer (P1) is such that i is zero for each R₁ of recurring units (R_{P1}) and recurring units (R*_{P1}).

In some embodiments, the copolymer (P1) is such that recurring units (R_{P1}) are according to formula (M1), (M2) or (M3):

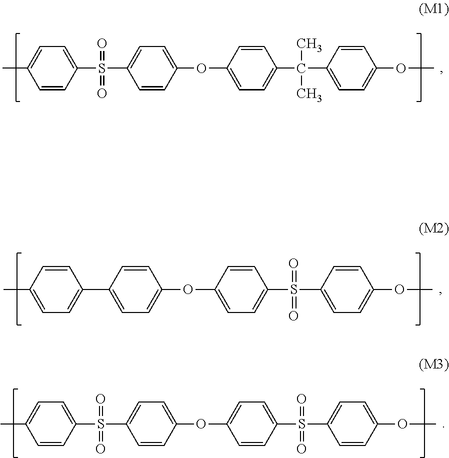

In some embodiments, the copolymer (P1) is such that it comprises:
recurring units (R*_{P1}) wherein the group G_{N} is according to formula (G_{N1}), preferably at least 25 mol. % of the recurring units (R*_{P1}) are such that the group G_{N} is according to formula (G_{N1}), more preferably at least 30 mol. %, even more preferably 35 mol. %;
recurring units (R*_{P1}) wherein the group G_{N} is according to formulas (G_{N1}) and (G_{N6}), preferably at least 35 mol. % of the recurring units (R*_{P1}) are such that the group G_{N} is according to formula (G_{N1}) and (G_{N6}), more preferably at least 40 mol. %, even more preferably 45 mol. %; or
at least recurring units (R*_{P1}) wherein the group G_{N} is according to formulas (G_{N1}), (G_{N4}) and (G_{N6}), preferably at least 50 mol. % of the recurring units (R*_{P1}) are such that the group G_{N} is according to formula (G_{N1}) and (G_{N6}), more preferably at least 60 mol. %, even more preferably 70 mol. %, 80 mol. % or 90 mol. %.

In some embodiments, the copolymer (P1) is such that k is zero and j is 3 in recurring units (R*_{P1}).

In some embodiments, the copolymer (P1) is such that W is —SO₂— in recurring units (R*_{P1}).

In some embodiments, the copolymer (P1) is such that the molar ratio of recurring units (R_{P1})/recurring units (R*_{P1}) varies between 0.01/100 and 100/0.01, preferably between 1/100 and 100/1, more preferably between 1/1 and 12/1, even more preferably between 4/1 and 10/1.

In some embodiments, copolymer (P1) is such that R₂ in recurring units (R*_{P1}) is independently selected from the group consisting of:
—CH₂—COOH,
—(CH₂)₂—OH,
—(CH₂)₂—NH₂,
—(CH₂)₃—SO₃Na,
—(CH₂)₃—Si (OCH₃)₃,
—(CH₂)₂—(CF₂)₇—CF₃,
—CHO,
—(CH₂)₉—CH₃, and
—CH₂-Ph, with Ph being benzene.

In some embodiments, the copolymer (P1) comprises collectively at least 50 mol. % of recurring units (R_{P1}) and (R*_{P1}), based on the total number of moles in the copolymer (P1). Copolymer (P1) may for example comprise collectively at least 60 mol. %, at least 70 mol. %, at least 80 mol. %, at least 90 mol. %, at least 95 mol. %, at least 99 mol. % of recurring units (R_{P1}) and (R*_{P1}), based on the total number of moles in the copolymer (P1). Copolymer (P1) may preferably consists essentially of recurring units (R_{P1}) and (R*_{P1}).

The PAES copolymer (P1) preferably has a glass transition temperature Tg greater than the Tgₕ of the homopolymer consisting essentially of the same PAES recurring units (R_{P1}), more preferably has a Tg≥5° C.+Tgₕ, yet more preferably Tg≥7° C.+Tgₕ, yet even more preferably Tg≥10° C.+Tgₕ.

When the PAES recurring units (R_{P1}) is of formula (M1) and the corresponding homopolymer is a PSU with a Tgₕ of about 185° C., the PAES copolymer (P1) comprising same PAES recurring units (R_{P1}) of formula (M1) and functionalized recurring units (R*_{P1}) of formula (N) in which, in formulae (G_{N1}) to (G_{N6}), W is a bond or —SO₂—, preferably —SO₂—, has a Tg≥Tg_{PSU}, preferably Tg≥3° C.+Tg_{PSU}, more preferably Tg≥5° C.+Tg_{PSU}, yet more preferably Tg≥7° C.+Tg_{PSU}, yet even more preferably Tg≥10° C.+Tg_{PSU}.

When the PAES recurring units (R_{P1}) is of formula (M2) and the homopolymer corresponds to a PPSU with a Tgₕ of about 220° C., the PAES copolymer (P1) comprising same PAES recurring units (R_{P1}) of formula (M2) and functionalized recurring units (R*_{P1}) of formula (N) in which, in formulae (G_{N1}) to (G_{N6}), W is a bond or —SO₂—, preferably —SO₂—, has a glass transition temperature Tg>Tg_{PPSU}, preferably Tg 3° C.+Tg_{PPSU}, more preferably Tg≥5° C.+Tg_{PPSU}, yet more preferably Tg≥7° C.+Tg_{PPSU}, yet even more preferably Tg≥10° C.+Tg_{PPSU}.

When the PAES recurring units (R_{P1}) is of formula (M3) and the homopolymer corresponds to a PES with a Tgₕ of about 220° C., the PAES copolymer (P1) comprising same PAES recurring units (R_{P1}) of formula (M3) and functionalized PAES recurring units (R*_{P1}) of formula (N) in which, in formulae (G_{N1}) to (G_{N6}), W is a bond or —SO₂—, preferably —SO₂—, has a Tg≥Tg_{PES}, preferably Tg≥3° C.+Tg_{PES}, more preferably Tg≥5° C.+Tg_{PES}, yet more preferably Tg≥7° C.+Tg_{PES}, yet even more preferably Tg≥10° C.+Tg_{PES}.

This is in contrast with what is described for functionalized PAES copolymers in which cysteamine was used during synthesis in WO 2020/187684A1 and WO 2021/123405A1, in which the glass transition temperature Tg of the copolymers described in the examples are less than the Tg of their corresponding homopolymers. The functionalized PSU copolymer (P1-C) of WO′684 prepared with cysteamine hydrochloride had a Tg of 175° C. (<Tg_{PSU}). The functionalized PSU copolymers (P1-A), (P1-B) and (P1-E) of WO′405 had a Tg of 150° C., 143° C. and 162° C. (<Tg_{PSU}). These functionalized PSU polymers were prepared from copolymer precursors made using DCDPS, diallylbisphenol A and bisphenol A.

The functionalized PPSU copolymer (P1-C) of WO′405 had a Tg of 170° C. (<Tg_{PPSU}), and this functionalized PPSU copolymer (P1-C) was prepared from a copolymer precursor made using DCDPS, diallylbisphenol A and 4,4′-biphenol.

The functionalized PES copolymer (P1-D) of WO′405 had a Tg of 190° C. (<Tg_{PES}), and this functionalized PES copolymer was prepared from a copolymer precursor made using DCDPS, diallylbisphenol A and bisphenol S.

The copolymer (P1) of the present invention may have a glass transition temperature Tg ranging from 170° C. and 240° C. or from 185° C. and 240° C., preferably from 190° C. and 240° C., more preferably from 195° C. and 240° C. or from 200 and 235° C.

The glass transition temperature is preferably measured by differential scanning calorimetry (DSC), preferably according to ASTM D3418. For example, DSC measurements may be carried out using a TA Instrument Q100 and are taken under a nitrogen purge. DSC curves are recorded by heating, cooling, re-heating, and then re-cooling the sample between 25° C. and 320° C. at a heating and cooling rate of 20° C./min. The reported Tg values are provided using the second heat curve unless otherwise noted.

The thio-ether bond —S—R₂ contained in recurring units (R*_{P1}) possesses several advantages. First, it is a stable non-hydrolyzable linkage which is important for applications in membranes, especially for medical applications. Moreover, it is a highly biocompatible and bio-stable linkage and can therefore be used for hemodialysis applications; many biological active molecules contain a thio-ether moiety, e.g. biotin. Yet, this bond can be oxidized to form sulfoxide and sulfone linkages upon treatment with a suitable oxidizing agent like hydrogen peroxide. Further, thio-ethers can be easily alkylated with alkyl halides to form sulfonium salts; polymeric sulfonium salts can then be used for chemical transformations such as epoxidation. In addition, thio-ethers can be coordinated or bonded to heavy metals, therefore the copolymer of the present invention can act as polymeric ligand for metal removal.

The copolymer (P1) of the present invention may be also characterized by its end groups. Polymer end groups are moieties at respective ends of the PAES copolymer (P1) chain.

Depending on the monomers used for making the copolymer (P0) from which the copolymer (P1) is prepared and the possible use of an additional end-capping agent during the polycondensation process, or the possible addition of a protonating agent after the polymerization (in order to obtain phenolic —OH end groups), the copolymer (P1) may possess, for example, end groups derived from the monomers and/or end groups derived from end-capping agents. Since the copolymer (P0) is generally manufactured by a polycondensation reaction between at least two dihydroxy components and a dihalo component and without end capping agents, the end groups of the copolymer (P1) usually include, or preferably consist of, hydroxyl end groups and halo end groups (such as chlorinated end groups). The manufacture of the copolymer (P0) from which copolymer (P1) is derived preferably excludes the use of aminophenol as end-capping agent, which would convert at least partially some halo end groups into amine end groups. The concentration of hydroxyl end groups can be determined by titration. The concentration of halogen groups can be determined with a halogen analyzer. Nevertheless, any suitable method may be used to determine the concentration of the end groups. For example, titration, NMR, FTIR or a halogen analyzer may be used.

### Process for Preparinq the Copolymer (P1)

Copolymer (P1) can be prepared by various chemical processes, for instance by free radical thermal reaction, by free radical UV reaction, by base-catalyzed reaction or by nucleophilic-catalyzed reaction.

The process for preparing copolymer (P1) comprises reacting an allyl/vinylene-functionalized copolymer (P0) with a compound of formula (I):

R₂—SH, (I)

wherein R₂ is independently selected from the group consisting of:
—(CH₂)ᵤ—COOH, with u being an integer from 1 to 5, preferably u being 1 or 2,
—(CH₂)ₖ—OH, with k being an integer from 1 to 5, preferably k being 1 or 2,
—(CH₂)ₚ—NRₐR_{b}, with p being an integer from 1 to 5, and a and b being independently a C1-C6 alkyl or H, with the proviso that Rₐ and R_{b} cannot be both CH₃; p being preferably 1 or 2, and Rₐ and R_{b} being preferably CH₃ or H,
—(CH₂)_{q}—SO₃Na, with q being an integer from 1 to 5, preferably q being 1, 2 or 3,
—(CH₂)ₐ—COCH₃, with a being an integer from 0 to 10,
—(CH₂)ᵣ—Si(OCH₃)₃, with r being an integer from 1 to 5, preferably r being 1, 2 or 3,
—(CH₂)ₛ—(CF₂)ₜ—CF₃, with s being an integer from 1 to 5, preferably 1 or 2, and t being an integer from 1 to 10, preferably from 5 to 9, and
—C(O)—R_{c}, with Rₑ being a C1-C6 alkyl or H, preferably H,
—(CH₂)ᵥ—CH₃, with v being an integer from 5 to 30, preferably v being selected from 8 to 20, and
—(CH₂)_{w}—Ar, with w being an integer from 1 to 10 and Ar comprises one or two aromatic or heteroaromatic rings, for example one or two benzene rings.

The copolymer (P0) used in the process of the present invention comprises recurring units (R*_{P0}) with 2 pendant allyl/vinylene side-chains, which are reactive with the compound R₂—SH. Copolymer (P0) more precisely comprises:
recurring units (R_{P0}) of formula (M):

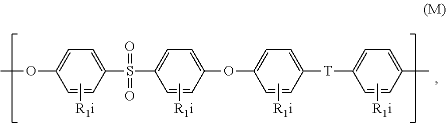

recurring units (R*_{P0}) of formula (P):

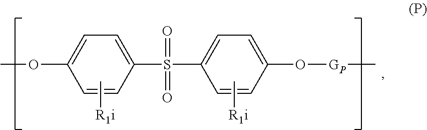

wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently selected from 0 to 4;
T is selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof,
G_{P} is selected from the group consisting of at least one of the following formulas (G_{P1}) to (G_{P3}):

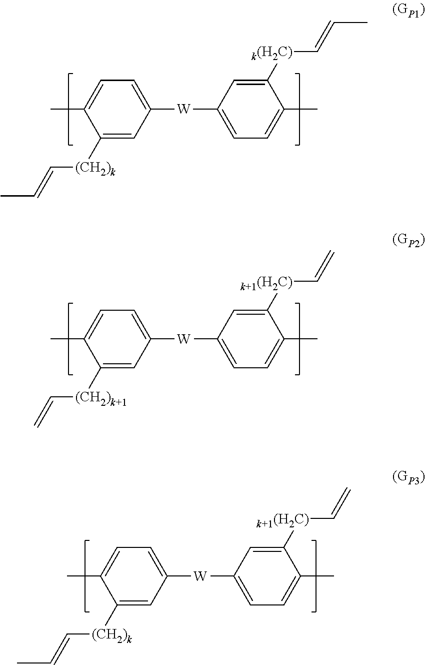

in which:
W is a bond or —SO₂—, preferably —SO₂—;
each k is independently an integer from 0 to 4.

When T and W are both —SO₂—, then u is not equal to 1 or 2.

In some embodiments, the copolymer (P0) is such that k is zero in recurring units (R*_{P0}).

The reaction to prepare the copolymer (P1) is preferably carried out in a solvent. When the reaction to prepare copolymer (P1) is carried out in a solvent, the solvent is for example a polar aprotic solvent selected from the group consisting of N-methylpyrrolidone (NMP), N-butylpyrrolidone (NBP), N-ethyl-2-pyrrolidone, N,N-dimethylformamide (DMF), N,N dimethylacetamide (DMAC), 1,3-dimethyl-2-imidazolidinone, tetrahydrofuran (THF), dimethyl sulfoxide (DMSO), chlorobenzene, anisole and sulfolane. The solvent may also be chloroform or dichloromethane (DCM). The reaction to prepare copolymer (P1) is preferably carried out in sulfolane or NMP.

The molar ratio of compound of formula (I)/polymer (P0) may vary between 0.01/100 and 100/0.01, preferably between 1/100 and 100/1, more preferably between 1/1 and 10/1.

The temperature of the reaction to prepare the copolymer (P1) varies between 10° C. and 300° C., preferably between room temperature and 200° C., or more preferably between 35° C. and 100° C.

In some embodiments, the copolymer (P0) is such that T in recurring units (R_{P0}) is selected from the group consisting of a bond, —SO₂—, —C(CH₃)₂— and any mixture therefrom. The copolymer (P0) may, for example, comprise recurring units (R_{P0}) in which T is —C(CH₃)₂—and recurring units (R_{P1}) in which T is —SO₂—.

T in recurring units (R_{P0}) is preferably —C(CH₃)₂—.

In some embodiments, the copolymer (P0) is such that each R₁ is independently selected from the group consisting of a C1-C12 moiety optionally comprising one or more than one heteroatoms; sulfonic acid and sulfonate groups; phosphonic acid and phosphonate groups; amine and quaternary ammonium groups.

In some embodiments, the copolymer (P0) is such that i is zero for each R₁ of recurring units (R_{P0}) and recurring units (R*_{P0}).

In some embodiments, the copolymer (P0) is such that j is 2 in recurring units (R_{P0}).

In some embodiments, the copolymer (P0) is such that the molar ratio of recurring units (R_{P0})/recurring units (R*_{P0}) varies between 0.01/100 and 100/0.01, preferably between 1/100 and 100/1.

In some embodiments, the copolymer (P0) is such that the recurring units (R_{P0}) are according to formulae (M1), (M2) or (M3):

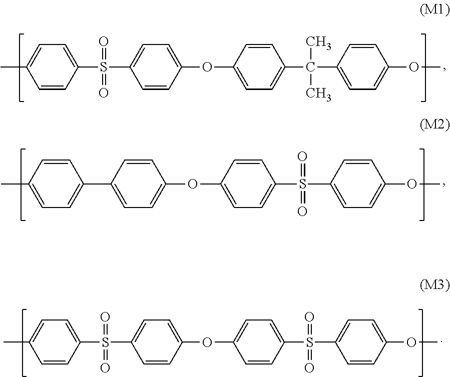

In some embodiments, the copolymer (P0) comprises collectively at least 50 mol. % of recurring units (R_{P0}) and (R*_{P0}), based on the total number of moles in the copolymer (P0). The copolymer (P0) may for example comprise collectively at least 60 mol. %, at least 70 mol. %, at least 80 mol. %, at least 90 mol. %, at least 95 mol. %, at least 99 mol. % of recurring units (R_{P0}) and (R*_{P0}), based on the total number of moles in the copolymer (P0). The copolymer (P0) preferably consists essentially of the recurring units (R_{P0}) and (R*_{P0}).

The copolymer (P0) has a glass transition temperature Tg being equal to or greater than the Tgₕ of the homopolymer consisting essentially of the same recurring units (R_{P0}), preferably has a Tg>Tgₕ, more preferably Tg≥5° C.+Tgₕ, yet more preferably Tg≥7° C.+Tgₕ, yet even more preferably Tg≥10° C.+Tgₕ, said glass transition temperatures being measured by differential scanning calorimetry (DSC), preferably according to ASTM D3418.

This is in contrast with what is described for functionalized PAES copolymers in which cysteamine was used during synthesis in WO 2020/187684A1 and WO 2021/123405A1, in which the Tg of the copolymers (P0) described in their examples are less than the Tg of their corresponding homopolymers. The allyl/vinylene-modified PSU copolymer (P0-A) of WO′684 had a Tg of 175° C. (<Tg_{PSU}). The allyl/vinylene-modified PSU copolymers (P0-A) and (P0-B) of WO′405 had a Tg of 160.5° C. and 154° C. (<Tg_{PSU}), and these copolymer precursors were made using DCDPS, diallylbisphenol A and bisphenol A. The allyl/vinylene-modified PPSU copolymer (P0-C) of WO′405 had a Tg of 179° C. (<Tg_{PPSU}), and this copolymer precursor (P0-C) was made using DCDPS, diallylbisphenol A and 4,4′-biphenol. The allyl/vinylene-modified PES copolymer (P0-D) of WO′405 had a Tg of 187° C. (<Tg_{PES}), and this copolymer precursor (P0-D) was made using DCDPS, diallylbisphenol A and bisphenol S.

According to an embodiment, the copolymer (P0) of the present invention may have a Tg ranging from 170 and 240° C., preferably from 180 and 240° C. or from 185° C. and 240° C., more preferably from 190° C. and 240° C., yet more preferably from 195° C. and 240° C. or from 195 and 235° C., said Tg being measured by DSC as described herein.

In some embodiments, the compound R₂— SH used to react the copolymer (P0) is such that R₂ in the recurring units (R*_{P1}) is independently selected from the group consisting of:
—CH₂—COOH,
—(CH₂)₂—OH,
—(CH₂)₂—NH₂,
—(CH₂)₃—SO₃Na,
—(CH₂)₃—Si(OCH₃)₃,
—(CH₂)₂—(CF₂)₇—CF₃,
—CHO,
—(CH₂)₉—CH₃, and
—CH₂-Ph, with Ph being benzene.

In some embodiments, the reaction to prepare the copolymer (P1) may be carried out in the presence of a base, for example selected from the group consisting of potassium carbonate (K₂CO₃), potassium tert-butoxide, sodium hydroxide (NaOH), potassium hydroxide (KOH), sodium carbonate (Na₂CO₃), cesium carbonate (Cs₂CO₃) and sodium tert-butoxide. The base may also be selected from the group consisting of N-Ethyl-N-(propan-2-yl)propan-2-amine (Hunig base), triethylamine (TEA) and pyridine.

In some embodiments, the reaction to prepare the copolymer (P1) may be carried out in the presence of:
at least one free radical initiator, preferably 2,2′-Azobis(2-methylpropionitrile) (AIBN), and/or
at least one catalyst, preferably selected from peroxides and hydroperoxides.

According to an embodiment, the amount of the copolymer (P1) at the end of the reaction is at least 10 wt. % based on the total weight of the copolymer (P0) and the solvent, for example at least 15 wt. %, at least 20 wt. % or at least 30 wt. %.

At the end of the reaction, the copolymer (P1) is separated from the other components (salts, base, . . . ) to obtain a solution. Filtration can for example be used to separate the copolymer (P1) from the other components. The solution can then be used as such for reacting the copolymer (P1) with other compounds, or alternatively, the copolymer (P1) can be recovered from the solvent, for example by coagulation or devolatilization of the solvent.

### Process for Preparing the Copolymer (P0)

In some embodiments, the allyl/vinylene-functionalized copolymer (P0) used in the process of the present invention has been prepared by condensation of at least one aromatic dihydroxy monomer (a1), with at least one aromatic sulfone monomer (a2) comprising at least two halogen substituents and at least one allyl-substituted aromatic dihydroxy monomer (a3).

The condensation to prepare the copolymer (P0) is preferably carried out in a solvent. When the condensation to prepare the copolymer (P0) is carried out in a solvent, the solvent is for example a polar aprotic solvent selected from the group consisting of N-methylpyrrolidone (NMP), N-butylpyrrolidone (NBP), N,Ndimethylformamide (DMF), N,N dimethylacetamide (DMAC), 1,3-dimethyl-2-imidazolidinone, tetrahydrofuran (THF), dimethyl sulfoxide (DMSO), chlorobenzene and sulfolane. The condensation to prepare copolymer (P0) is preferably carried out in sulfolane or NMP.

The condensation to prepare the copolymer (P0) may be carried out in the presence of a base, for example selected from the group consisting of potassium carbonate (K₂CO₃), potassium tert-butoxide, sodium hydroxide (NaOH), potassium hydroxide (KOH), sodium carbonate (Na₂CO₃), cesium carbonate (Cs₂CO₃) and sodium tert-butoxide. The base acts to deprotonate the components (a1) and (a3) during the condensation reaction.

The molar ratio (a1)+(a3)/(a2) may be from 0.9 to 1.1, for example from 0.92 to 1.08 or from 0.95 to 1.05.

In some embodiments, the monomer (a2) is a 4,4-dihalosulfone comprising at least one of a 4,4′-dichlorodiphenyl sulfone (DCDPS) or 4,4′ difluorodiphenyl sulfone (DFDPS), preferably DCDPS.

In some embodiments, the monomer (a1) comprises, based on the total weight of the monomer (a1), at least 50 wt. % of 4,4′ dihydroxybiphenyl (biphenol), at least 50 wt. % of 2,2-bis(4-hydroxyphenyl)propane (bisphenol A) or at least 50 wt. % of 4,4′ dihydroxydiphenyl sulfone (bisphenol S).

In some embodiments, the monomer (a3) comprises, based on the total weight of the monomer (a1), at least 50 wt. % of 2,2′-diallylbisphenol A (DABA).

According to the condensation to prepare copolymer (P0), the monomers of the reaction mixture are generally reacted concurrently. The reaction is preferably conducted in one stage. This means that the deprotonation of monomers (a1) and (a3) and the condensation reaction between the monomers (a1)/(a3) and (a2) takes place in a single reaction stage without isolation of the intermediate products.

According to an embodiment, the condensation is carried out in a mixture of a polar aprotic solvent and a solvent which forms an azeotrope with water. The solvent which forms an azeotrope with water includes aromatic hydrocarbons such as benzene, toluene, xylene, ethylbenzene, chlorobenzene and the like. It is preferably toluene or chlorobenzene. The azeotrope forming solvent and polar aprotic solvent are used typically in a weight ratio of from about 1:10 to about 1:1, preferably from about 1:5 to about 1:1. Water is continuously removed from the reaction mass as an azeotrope with the azeotrope forming solvent so that substantially anhydrous conditions are maintained during the polymerization. The azeotrope-forming solvent, for example, chlorobenzene, is removed from the reaction mixture, typically by distillation, after the water formed in the reaction is removed leaving the copolymer (P0) dissolved in the polar aprotic solvent.

The temperature of the reaction mixture to prepare copolymer (P0) is kept at about 150° C. to about 350° C., preferably from about 210° C. to about 300° C. for about one to 15 hours.

The inorganic constituents, for example sodium chloride or potassium chloride or excess of base, can be removed, before or after isolation of the copolymer (P0), by suitable methods such as dissolving and filtering, screening or extracting.

According to an embodiment, the amount of copolymer (P0) at the end of the condensation is at least 30 wt. % based on the total weight of the copolymer (P0) and the polar aprotic solvent, for example at least 35 wt. % or at least or at least 37 wt. % or at least 40 wt. %.

At the end of the reaction, the copolymer (P0) is separated from the other components (salts, base, . . . ) to obtain a solution. Filtration can for example be used to separate the copolymer (P0) from the other components. The solution can then be used as such for reacting the copolymer (P0) with the compound R₂— SH in the process of the present invention, or alternatively, the copolymer (P0) can be recovered from the solvent, for example by coagulation or devolatilization of the solvent.

### Applications

The copolymer (P1) of the present invention may be used in the preparation of functional membranes. For example, these membranes may be hydrophobic, hydrophilic, bio-labeled, for example membranes with fluorescent tags.

The copolymer (P1) of the present invention may also be used in the preparation of composite materials. In this application, the functionalities improve the adhesion of the resin to the reinforcing fibers thereby improving performance.

The copolymer (P1) of the present invention may also be used in the preparation of functional coatings. Chemical moieties on the surface of the coatings can be selected to make the coating hydrophobic, hydrophilic, bio-taggable, anti-microbial, anti-fouling and/or UV curable.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### EXAMPLES

### Raw Materials

DCDPS (4,4′-dichlorodiphenyl sulfone), available from Solvay Speciality Polymers
BPA (bisphenol A), available from Covestro, U.S.A.
BP (biphenol), polymer grade available from Honshu Chemicals, Japan
daBPA-S (2,2′-diallyl Bisphenol S), available from Toronto Research Chemicals.
K₂CO₃ (Potassium Carbonate), available from Armand products
NMP (2-methyl pyrrolidone), available from Sigma-Aldrich, U.S.A.
MCB (methylchlorobenzene), available from Sigma-Aldrich, U.S.A.
ADVN (2,2′-azobis(2,4-dimethylvaleronitrile)), available from Miller-Stephenson Chemical Co., Inc, U.S.A.
AIBN (2,2-Azobis(2-methylpropionitrile)), available from Sigma Aldrich, U.S.A.

### Test Methods

### GPC—Molecular Weight (Mn, Mw)

Method 1: The molecular weights were measured by gel permeation chromatography (GPC), using methylene chloride as a mobile phase. Two 5p mixed D columns with guard column from Agilent Technologies were used for separation. An ultraviolet detector of 254 nm was used to obtain the chromatogram. A flow rate of 1.5 mL/min and injection volume of 20 μL of a 0.2 w/v % solution in mobile phase was selected. Calibration was performed with 12 narrow molecular weight polystyrene standards (Peak molecular weight range: 371,000 to 580 g/mol). The number average molecular weight Mn, weight average molecular weight Mw, higher average molecular weight Mz, were reported.

Method 2: Viscotek GPC Max (Autosampler, pump, and degasser) with a TDA302 triple detector array comprised of RALS (Right Angle Light Scattering), RI and Viscosity detectors was used. Samples were run in NMP with 0.2 w/w % LiBr at 65° C. at 1.0 mL/min through a set of 3 columns: a guard column (CLM1019—with a 20 k Da exclusion limit), a high Mw column (CLM1013 exclusion of 10MM Daltons relative to Poly Styrene) and a low Mw column (CLM1011—exclusion limit of 20 k Daltons relative to PS). Calibration was done with a single, mono-disperse polystyrene standard of ˜100 k Da. Light Scattering, RI, and Viscosity detectors were calibrated based on a set of input data supplied with the standards.Samples were prepared as ˜2 mg/mL in NMP/LiBr.

Viscotek's OMNISec v4.6.1 Software was used for data analysis. The number average molecular weight Mn, weight average molecular weight Mw, higher average molecular weight Mz, were reported.

### Thermal Gravimetric Analysis (TGA)

TGA experiments were carried out using a TA Instrument TGA Q500. TGA measurements were obtained by heating the sample at a heating rate of 10° C./min from 20° C. to 800° C. under nitrogen.

### ¹H NMR

¹H NMR spectra were measured using a 400 MHz Bruker spectrometer with TCE or DMSO as the deuterated solvent. All spectra are reference to residual proton in the solvent.

### DSC

DSC was used to determine glass transition temperatures (Tg) and melting points (Tm)-if present. DSC experiments were carried out using a TA Instrument Q100. DSC curves were recorded by heating, cooling, re-heating, and then re-cooling the sample between 25° C. and 320° C. at a heating and cooling rate of 20° C./min. All DSC measurements were taken under a nitrogen purge. The reported Tg (and Tm, if any) values were provided using the second heat curve unless otherwise noted.

### I. Preparation of Copolymer (P0-A)

### The Copolymer (P0-A) was Prepared According to Scheme 1.

The polymerization was carried out in a glass reactor vessel (1 L) fitted with an overhead stirrer, nitrogen inlet and an overhead distillation set-up. The monomers 4,4′-dichlorodiphenyl sulfone (143.58 g), Bisphenol A (102.73 g) and 2,2′ diallyl bisphenol S (16.52 g) were added to the vessel first, followed by the addition of potassium carbonate (78.29 g), and NMP (690 g) and chlorobenzene (170 g).The reaction mixture was heated from room temperature to 190° C. using a 150° C./min heating ramp, with continuous removal of the chlorobenzene using a Dean-Stark apparatus. The temperature of the reaction mixture was maintained for around eight hours, depending upon the viscosity of the solution. The reaction was stopped by turning off the heat and diluting the reaction mixture with cold solvent. The reaction mixture was filtered, coagulated into methanol and dried at 110° C.

### Characterization of Copolymer (P0-A)

GPC (Method 1): Mn=12743 g/mol, Mw=58832 g/mol, PDI=4.61
TGA: 477° C.; DSC: Tg=195° C.

¹H NMR: The presence of unsaturated groups was confirmed by the appearance of a multiplet at 6.1-6.4 ppm which indicates the incorporation of the 2,2′-diallyl BPS monomer in the polymer.

### II. Preparation of Copolymer (P0-B)

### The Copolymer (P0-B) was Prepared According to Scheme 2.

The polymerization was carried out in a glass reactor vessel (1 L) fitted with an overhead stirrer, nitrogen inlet and an overhead distillation set-up. The monomers 4,4′-dichlorodiphenyl sulfone (172.29 g), 4,4′ biphenol (106.13 g) and 2,2′ diallyl bisphenol S (9.91 g) were added to the vessel first, followed by the addition of potassium carbonate (93.69 g), and sulfolane (570 g).The reaction mixture was heated from room temperature to 210° C. using a 150° C./mi heating ramp. The temperature of the reaction mixture was maintained for around five hours, depending upon the viscosity of the solution. The reaction was stopped by removing the heat and diluting with more solvent. The reaction mixture was filtered, coagulated into methanol and dried at 110° C.

### Characterization of Copolymer (P0-B)

GPC (Method 1): Mn=19251 g/mol, Mw=71960 g/mol, PDI=3.70.
TGA: 505° C.; DSC: Tg=235° C.

¹H NMR: spectrum was not obtained due to poor solubility in the NMR solvents.

### III. Preparation of Functionalized Copolymer (P1-A) by Free Radical Reaction

The copolymer (P1-A) according to the invention was prepared according to Scheme 3.

In a 250 mL three necked flask equipped with a nitrogen inlet, a thermocouple and an overhead stirrer, 31.2 g of the copolymer (P0-A) prepared according to Section I. above (Scheme 1) was dissolved in 89 g of NMP and 3.2 g of cysteamine.HCl was added. The reaction mixture was heated to 50° C. under nitrogen then 0.8 g of ADVN was added in one portion. The reaction was continued for 24 hours after which the reaction mass was coagulated into methanol, the precipitated polymer was then washed with methanol, water and then finally with methanol and dried at 110° C. under reduced pressure.

### Characterization

GPC (Method 2): Mw=152023 g/mol, Mn=50044 g/mol, PDI=3.30
DSC: Tg=206° C.; TGA: 411° C.

The quantitative estimation of the amine functionalization was analyzed by titrating the amine groups. Amine content: 295 microeq/g.

### Preparation of Functionalized Copolymer (P1-B) by Free Radical Reaction

The copolymer (P1-B) according to the invention was prepared according to the Scheme 4.

In a 250 mL three necked flask equipped with a nitrogen inlet, a thermocouple and an overhead stirrer, 30 g of the copolymer (P0-B) prepared according to Section II. above (Scheme 2) was dissolved in 110 g of NMP and 3.9 g of sodium 3-mercapto-1-propanesulfonate was added. The reaction mixture was heated to 75° C. under nitrogen then 0.59 g of AIBN was added in one portion.

The reaction was continued for 24 hours after which the reaction mass was coagulated into methanol, the precipitated polymer was then washed with methanol, water and then finally with methanol and dried at 110° C. under reduced pressure.

### Characterization

GPC (Method 2): Mw=342287 g/mol, Mn=75154 g/mol, PDI=4.50
DSC: Tg=234C; TGA: 517° C.
Sodium content: 1337 ppm

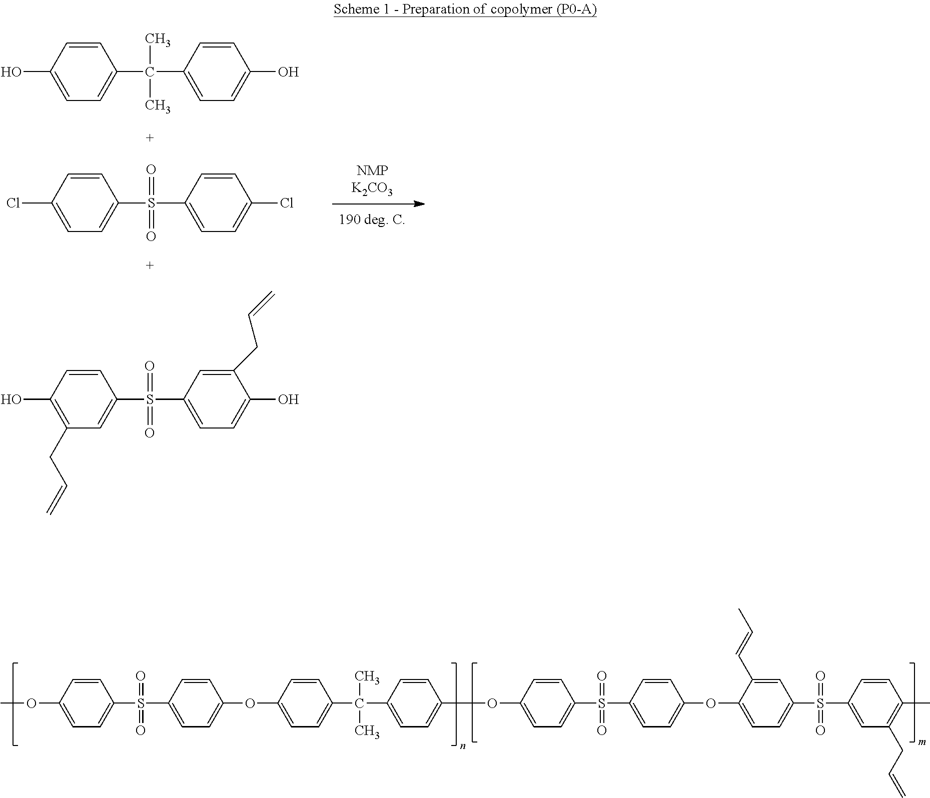

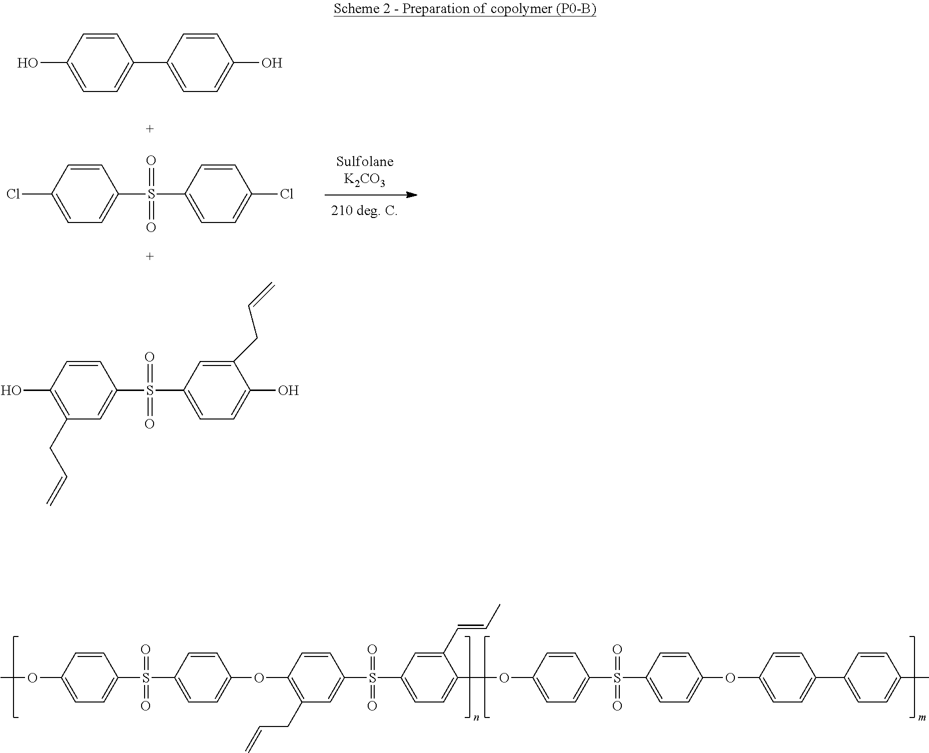

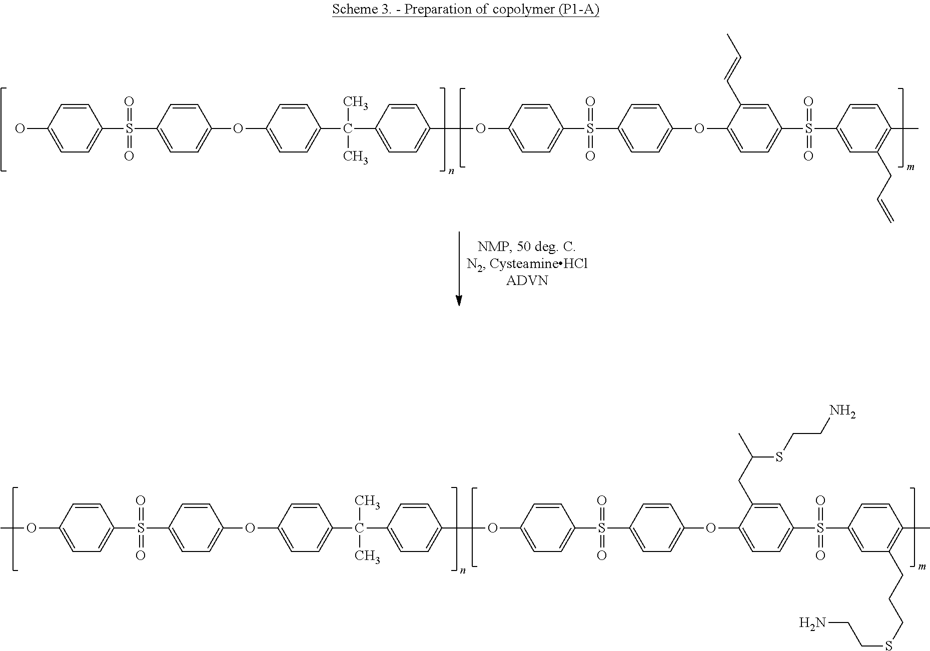

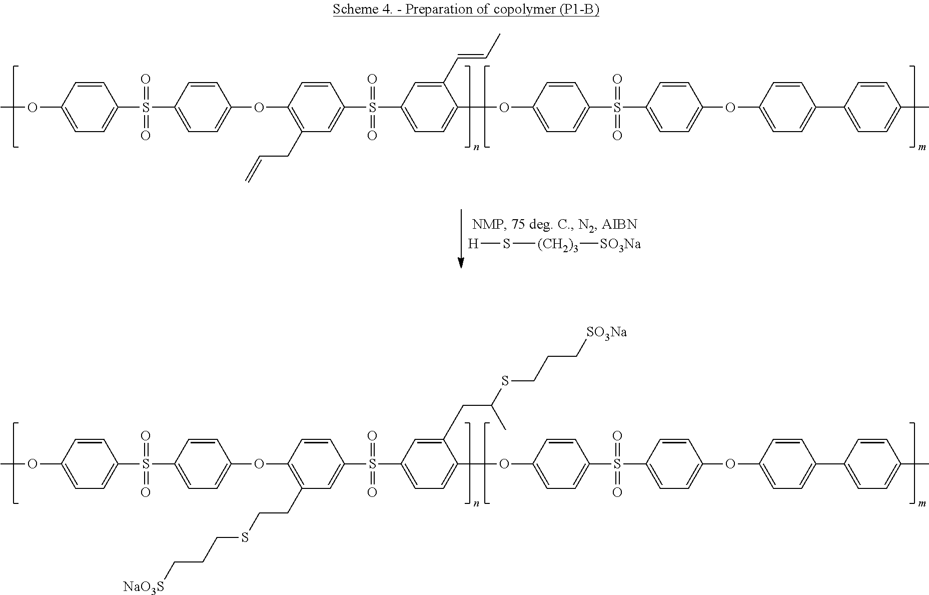

1. A copolymer (P1) comprising:
recurring units (R_{P1}) of formula (M): 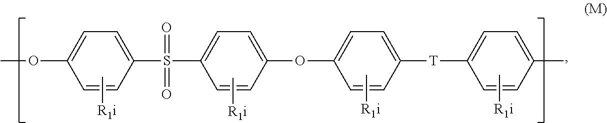
recurring units (R*_{P1}) of formula (N): 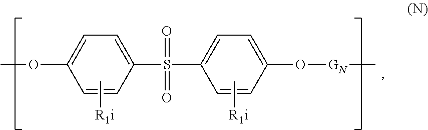
wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently an integer from 0 to 4;
T is selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof,
G_{N} is selected from the group consisting of at least one of the following formulas (G_{N1}) to (G_{N6}): 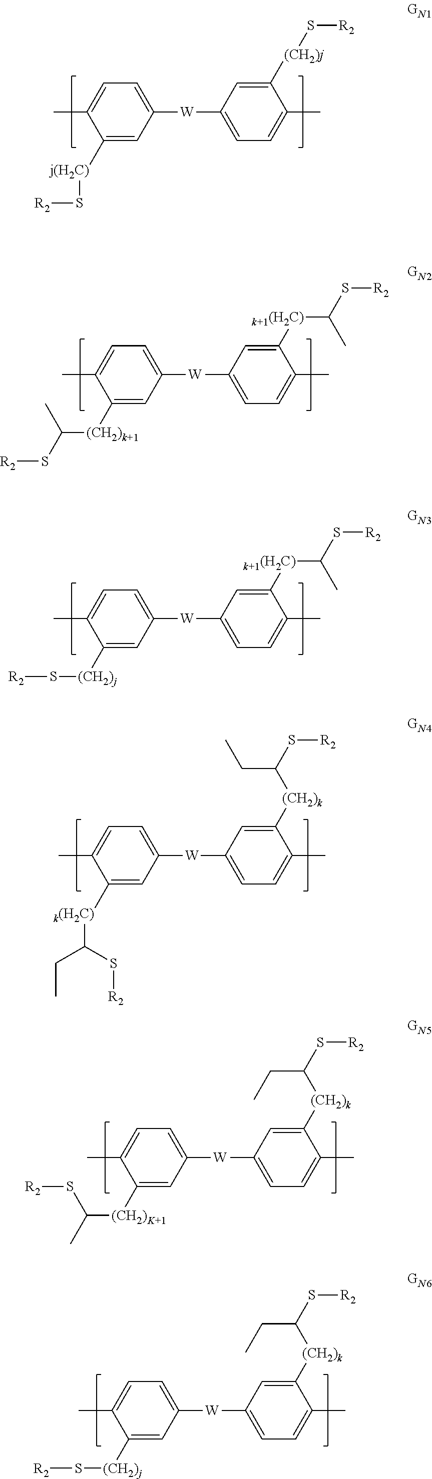
in which
W is a bond or —SO₂—, preferably —SO₂—;
each k is independently an integer from 0 to 4;
each j is independently an integer from 3 to 7;
each R₂ is independently selected from the group consisting of:
—(CH₂)ᵤ—COOH, with u being an integer from 1 to 5, with the proviso that when T and W are both —SO₂— then u is not 1 or 2,
—(CH₂)ₖ—OH, with k being an integer from 1 to 5,
—(CH₂)ₚ—NRₐR_{b}, with p being an integer from 1 to 5, and a and b being independently a C1-C6 alkyl or H, with the proviso that Rₐ and R_{b} cannot be both CH₃,
—(CH₂)_{q}—SO₃Na, with q being an integer from 1 to 5,
—(CH₂)ₐ—COCH₃, with a being an integer from 0 to 10
—(CH₂)ᵣ—Si(OCH₃)₃, with r being an integer from 1 to 5,
—(CH₂)ₛ—(CF₂)ₜ—CF₃, with s being an integer from 1 to 5 and t being an integer from 1 to 10,
—C(O)—R_{c}, with Rₑ being a C1-C6 alkyl or H,
—(CH₂)ᵥ—CH₃, with v being an integer from 5 to 30, and
—(CH₂)_{w}—Ar, with w being an integer from 1 to 10 and Ar comprising one or two aromatic or heteroaromatic rings; and
wherein the copolymer (P1) has a glass transition temperature Tg being equal to or greater than the Tgₕ of the homopolymer consisting essentially of the same recurring units (R_{P1}), said glass transition temperatures being measured by differential scanning calorimetry (DSC).

2. The copolymer (P1) of claim 1, wherein T in recurring units (R_{P1}) is selected from the group consisting of a bond, —SO₂—and —C(CH₃)₂—.

3. The copolymer (P1) of m claim 1, wherein i is zero for each R₁ of the recurring units (R_{P1}) and the recurring units (R*_{P1}).

4. The copolymer (P1) claim 1, wherein k is 0 and j is 3 in the recurring units (R*_{P1}).

5. The copolymer (P1) of claim 1, wherein the molar ratio of recurring units (R_{P1})/recurring units (R*_{P1}) varies between 1/100 and 100/1.

6. The copolymer (P1) of claim 1, wherein the recurring units (R_{P1}) are according to formulae (M1), (M2) or (M3):

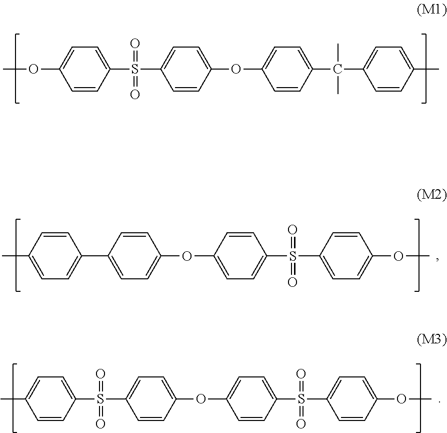

7. The copolymer (P1) of claim 1, wherein R₂ in the formulas (G_{N1}), (G_{N2}), (G_{N3}), (G_{N4}), (G_{N5}) or (G_{N6}) is independently selected from the group consisting of:
—CH₂—COOH,
—(CH₂)₂—OH,
—(CH₂)₂—NH₂,
—(CH₂)₃—SO₃Na,
—(CH₂)₃—Si(OCH₃)₃,
—(CH₂)₂—(CF₂)₇—CF₃,
—CHO,
—(CH₂)₉—CH₃, and
—CH₂-Ph, with Ph being benzene.

8. The copolymer (P1) of claim 1, comprising collectively at least 50 mol. % of the recurring units (R_{P1}) and (R*_{P1}), based on the total number of moles of recurring units in the copolymer (P1).

9. A process for preparing the copolymer (P1) of CLAIM 1, comprising reacting in a solvent a copolymer (P0) comprising:
recurring units (R_{P0}) of formula (M): 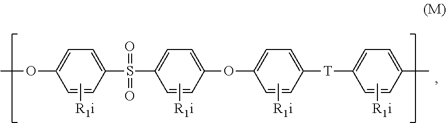
and
recurring units (R*_{P0}) of formula (P): 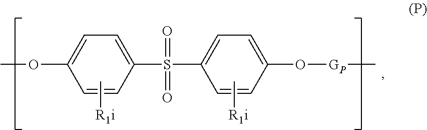
wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently an integer from 0 to 4;
T is selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof,
G_{P} is selected from the group consisting of at least one of the following formulas (G_{P1}) to (G_{P3}): 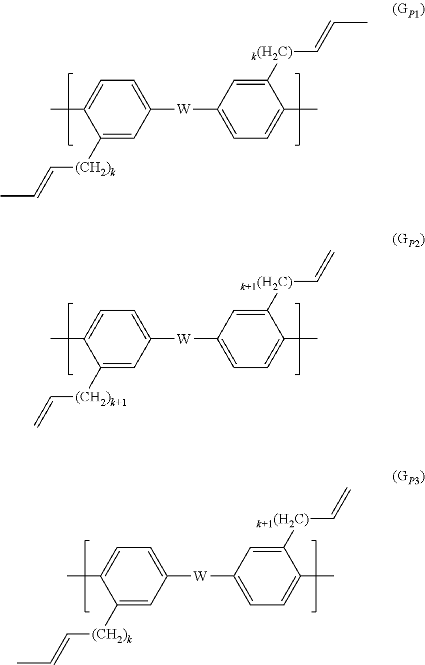
in which:
W is a bond or —SO₂—, preferably —SO₂—;
each k is independently selected from 0 to 4,
wherein the copolymer (P0) has a glass transition temperature Tg being equal to or greater than the Tgₕ of the homopolymer consisting essentially of the same recurring units (R_{P0}), said glass transition temperatures being measured by differential scanning calorimetry (DSC), with a compound of formula (I):
R₂— SH (I)
wherein R₂ is selected from the group consisting of:
—(CH₂)ᵤ—COOH, with u being an integer from 1 to 5, with the proviso that when T and W are both —SO₂—then u is not 1 or 2,
—(CH₂)ₖ—OH, with k being an integer from 1 to 5,
—(CH₂)ₚ—NRₐR_{b}, with p being an integer from 1 to 5, and Rₐ and R_{b} being independently a C1-C6 alkyl or H, with the proviso that Rₐ and R_{b} cannot be both CH₃,
—(CH₂)_{q}—SO₃Na, with q being an integer from 1 to 5,
—(CH₂)ₐ—COCH₃, with a being an integer from 0 to 10,
—(CH₂)ᵣ—Si(OCH₃)₃, with r being an integer from 1 to 5,
—(CH₂)ₛ—(CF₂)ₜ—CF₃, with s being an integer from 1 to 5 and t being an integer from 1 to 10,
—C(O)—R_{c}, with Rₑ being a C1-C6 alkyl or H,
—(CH₂)ᵥ—CH₃, with v being an integer from 5 to 30, and
—(CH₂)_{w}—Ar, with w being an integer from 1 to 10 and Ar comprising one or two aromatic or heteroaromatic rings,
wherein the molar ratio of compound (I)/polymer (P0) varies between 0.01/100 and 100/0.01, at a temperature ranging from 10° C. and 300° C.

10. The process of claim 9, being carried out in a solvent selected from the group consisting of N-methylpyrrolidone (NMP), N-butylpyrrolidone (NBP), N-ethyl-2-pyrrolidone, N,N-dimethylformamide (DMF), N,N dimethylacetamide (DMAC), 1,3-dimethyl-2-imidazolidinone, tetrahydrofuran (THF), dimethyl sulfoxide (DMSO), chlorobenzene, anisole, chloroform, dichloromethane (DCM) and sulfolane.

11. The process of claim 9, being carried out in the presence of:
at least one free radical initiator, and/or
at least one catalyst, and/or
in the presence of a base.

12. The process of claim 9, being carried out by exposing the reaction mixture to UV light at a wavelength ranging from 300 nm to 600 nm.

13. The process of a claim 9, wherein the functionalized PAES copolymer (P0) comprises collectively at least 50 mol. % of the recurring units (R_{P0}) and (R*_{P0}), based on the total number of moles of recurring units in the copolymer (P0).

14. The process of claim 9, wherein the functionalized PAES copolymer (P0) is prepared by condensation of at least one aromatic dihydroxy monomer (a1), with at least one aromatic sulfone monomer (a2) comprising at least two halogen substituents and at least one allyl-substituted aromatic dihydroxy monomer (a3).

15. A method for the preparation of a membrane, a composite material or a coating, comprising using the copolymer (P1) of claim 1.

16. The copolymer (P1) of claim 1, wherein the molar ratio of recurring units (R_{P1})/recurring units (R*_{P1}) varies between 1/100 and 100/1.

17. The process of claim 9, wherein Tg≥5° C.+Tgₕ.
